(19) United States
(12) Patent Application Publication
(10) Pub. No.: US 2017/0316315 A1
(43) Pub. Date: Nov. 2, 2017

(54) ONTOLOGY-BASED REASONING APPARATUS AND METHOD USING KNOWLEDGE OF AN EXPERT

(71) Applicant: FOUNDATION OF SOONGSIL UNIVERSITY INDUSTRY COOPERATION, Seoul (KR)

(72) Inventors: Young Tack PARK, Seoul (KR); Hyun Kyu PARK, Seoul (KR)

(21) Appl. No.: 15/470,886

(22) Filed: Mar. 27, 2017

(30) Foreign Application Priority Data
Apr. 27, 2016 (KR) 10-2016-0051645

(51) Int. Cl. G06N 5/02; G06F 17/30; G06N 5/04; G06F 3/0481

(52) U.S. Cl. CPC G06N 5/02; G06N 5/04; G06F 17/30979; G06F 3/0481

(57) ABSTRACT

Ontology-based reasoning apparatus and method using knowledge of an expert are disclosed. The ontology-based reasoning apparatus includes an input unit through which a plurality of the knowledge of the expert including a condition and a result are inputted, a conversion unit configured to convert the inputted knowledge to ontology-based rules, and a reasoning performing unit configured to reason a conclusion by using the converted rules and generate an explanation of a rule corresponding to cause of the conclusion. Here, the rule includes a condition node corresponding to the condition, a result node corresponding to the result and an edge for connecting the condition node to the result node, the edge includes an edge direction and an edge value, and the edge value corresponds to an explanation about relation between the condition node and the result node.

### PRIORITY

This application claims priority under 35 U.S.C. §119(a) to a Korean patent application filed on Apr. 27, 2016 in the Korean Intellectual Property Office and assigned Serial No. 10-2016-0051645, the entire disclosure of which is incorporated herein by reference.

### TECHNICAL FIELD

The present disclosure relates to reasoning apparatus and method of obtaining and managing knowledge of an expert through interaction with the expert, reasoning the obtained knowledge based on ontology, and providing logical explanation about the knowledge of the expert.

### BACKGROUND ART

A knowledge acquisition system has been widely used in a professional field such as a medical field and a legal field and a manufacturing field. That is, the knowledge acquisition system reduces repetitive work load by helping decision of an expert, and enhances efficiency and reliability of a decision process of experts through standardization of an accumulated experimental knowledge of the expert. Knowledge acquisition is a process of obtaining and analyzing knowledge of the expert and managing systematically the knowledge. Accordingly, a knowledge engineer for managing the knowledge is required so that a computer can manage an expert for supplying and verifying a domain knowledge and knowledge acquired from the expert.

Ontology is a dictionary including a concept and relation of the concepts. In the ontology, the relation of the concepts is hierarchically expressed, and conceptual expansion is practicable through reasoning by expressing an expression about a specific concept through the concept or the relation. Accordingly, a reasoning service for expanding explicit knowledge using the ontology may be provided.

A language for expressing the ontology includes a Resource Description Framework RDF, a RDF schema RDF-S, an Ontology Web Language OWL, and so on. Since the OWL includes abundant expression ability and formal semantics, it has been widely used.

However, a problem exists that the knowledge engineer is absolutely required in an overall process for applying the knowledge obtained from the expert to a system. Additionally, the knowledge engineer compensates, verifies and manages continuously the obtained knowledge, and thus excessive cost occurs and it is difficult to obtain new domain knowledge. Furthermore, since the knowledge of the knowledge engineer is lack compared to the expert in corresponding field, a problem exists in usage and verification of the knowledge occurs.

For example, in a domain for Diagnosis result analysis of the expert (doctor) using blood screening test information, the conventional knowledge acquisition system is composed of one-dimensional rule of IF-THEN. A case occurs that the expert can't perform addition, amendment and deletion of the knowledge due to absence of the knowledge engineer.

### SUMMARY

Accordingly, the invention is provided to substantially obviate one or more problems due to limitations and disadvantages of the related art. One embodiment of the invention provides reasoning apparatus and method of obtaining and managing knowledge of an expert through interaction with the expert, reasoning the obtained knowledge based on ontology, and providing logical explanation about the knowledge of the expert.

Other features of the invention may be thought by a person in an art through following embodiments.

In one embodiment, the invention provides an ontology-based reasoning apparatus using knowledge of an expert comprising: an input unit through which a plurality of the knowledge of the expert including a condition and a result are inputted; a conversion unit configured to convert the inputted knowledge to ontology-based rules; and a reasoning performing unit configured to reason a conclusion by using the converted rules and generate an explanation of a rule corresponding to cause of the conclusion. Here, the rule includes a condition node corresponding to the condition, a result node corresponding to the result and an edge for connecting the condition node to the result node, the edge includes an edge direction and an edge value, and the edge value corresponds to an explanation about relation between the condition node and the result node.

The input unit transmits an UI (user interface) for obtaining the knowledge to a terminal of the expert. Here, the UI includes an information display window for displaying needed information when inputting the condition and the result, a condition input window for receiving the condition and a result input window for receiving the result.

Each of the condition node and the result node includes a node name and a node value, and the edge direction may be set from the condition node to the result node.

The edge value includes a Definition for determining a node value of the condition node to a node value of the result node by generalizing the node value of the condition node, a Causal for expressing information corresponding to cause of the result node in a rule having the Definition, and a Diagnosis for expressing information corresponding to the conclusion based on the result node in the rule having the Definition.

When reasoning the conclusion about a rule A having the Definition of the converted rules, the reasoning performing unit searches a rule B which has Diagnosis and a result node of the rule A as a condition node, and reasons a result node of the rule B as the conclusion, and searches a rule C which has Causal and the result node of the rule A/the condition node of the rule B as a result node and generates an explanation about a rule corresponding to cause of the conclusion by using the rule C.

The reasoning performing unit searches a rule D which has the Causal and a condition node of the rule C as a result node, and generates an explanation about a rule corresponding to the cause of the conclusion by using further the rule D.

In another embodiment, the invention provides an ontology-based reasoning method using knowledge of an expert in an apparatus including a processor, the method comprising: receiving a plurality of the knowledge of the expert including a condition and a result; converting the received knowledge to ontology-based rules; reasoning a conclusion using the converted rules; and generating an explanation about a rule corresponding to cause of the conclusion. Here, wherein the rule includes a condition node corresponding to the condition, a result node corresponding to the result and an edge for connecting the condition node to the result node, the edge includes an edge direction and an edge value, and the edge value corresponds to an explanation about relation between the condition node and the result node.

Ontology-based reasoning apparatus and method using knowledge of an expert according to the invention obtain and manage knowledge of the expert through interaction with the expert, reason the obtained knowledge based on ontology and provide logical explanation about the knowledge of the expert.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating schematically an ontology-based reasoning apparatus using knowledge of an expert according to one embodiment of the invention;

FIG. 2 is a view illustrating an example of the UI according to one embodiment of the invention;

FIG. 3, FIG. 4A, FIG. 4B and FIG. 4C are views illustrating concept of a rule according to one embodiment of the invention;

FIG. 5 is a view illustrating operation of the reasoning performing unit according to one embodiment of the invention; and

FIG. 6 is a flowchart illustrating an ontology-based reasoning method using knowledge of the expert according to one embodiment of the invention.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, various embodiments of the invention will be described in detail with reference to accompanying drawings.

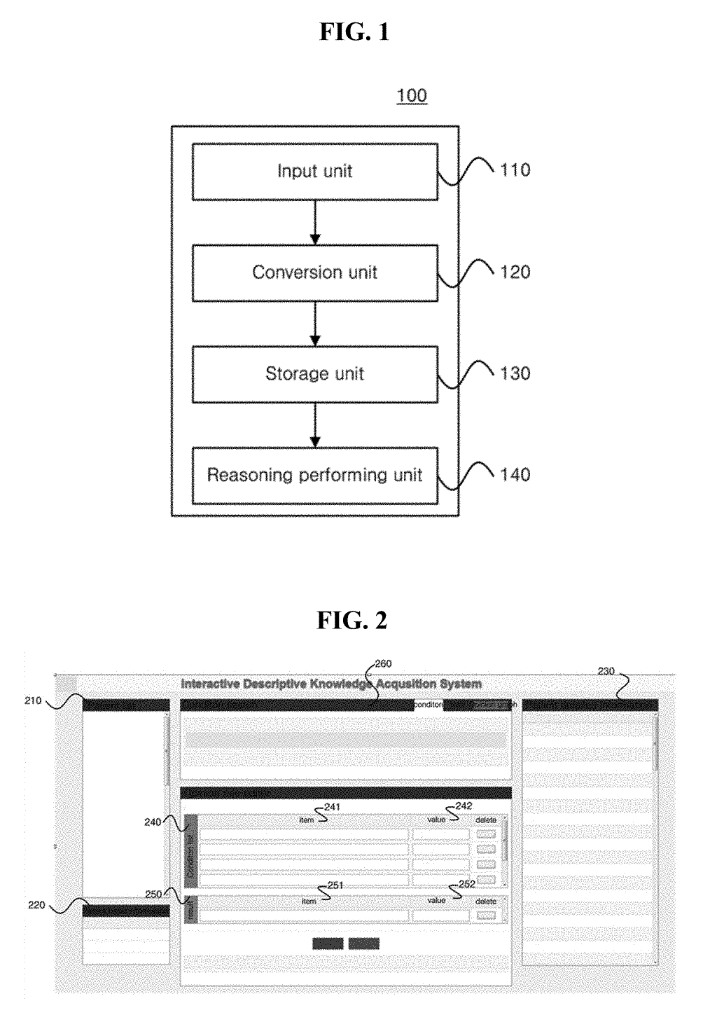

FIG. 1 is a view illustrating schematically an ontology-based reasoning apparatus using knowledge of an expert according to one embodiment of the invention.

In FIG. 1, the ontology-based reasoning apparatus 100 of the present embodiment includes an input unit 110, a conversion unit 120, a storage unit 130 and a reasoning performing unit 140. Hereinafter, function of elements will be described in detail.

The input unit 110 receives a plurality of knowledge of an expert. That is, the input unit 110 receives the knowledge of the expert through interaction with the expert. Here, the knowledge includes a condition and a result.

In one embodiment, the input unit 110 may user interface UI for obtaining the knowledge to a terminal of the expert. Here, the UI may include an information display window for displaying information needed when condition and result are inputted, a condition input window through which the condition is inputted and a result input window through which the result is inputted.

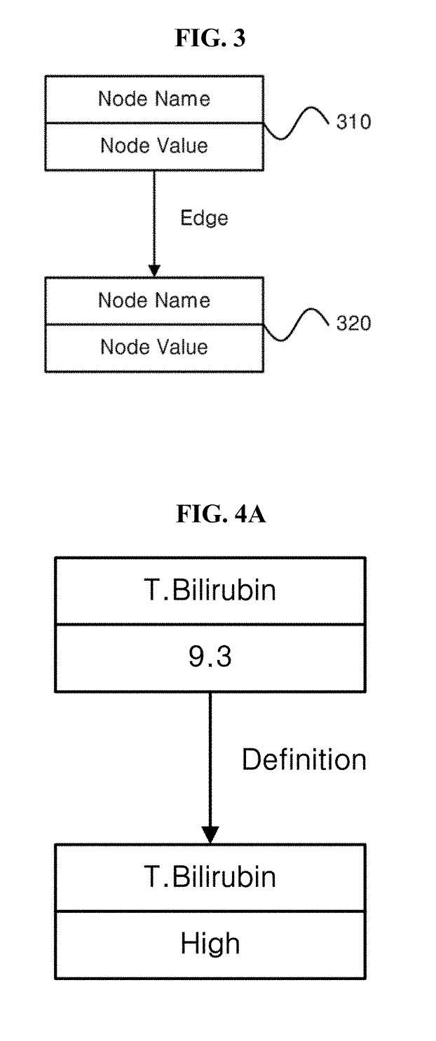

FIG. 2 is a view illustrating an example of the UI according to one embodiment of the invention.

Particularly, UI in FIG. 2 is an example of a medical field domain where a doctor as the expert judges blood screening test information and draws a result according to the judgment.

In FIG. 2, the UI includes a patient list 210, patient basic information 220 and patient detailed information 230 which are information display windows of the domain.

In addition, the UI includes a condition list 240 which is a condition input window for receiving the condition. The expert (doctor) inputs a condition in the condition input window considering information displayed in the information display window. Here, the inputted condition may include an item (name) 241 and a value 242. Two or more conditions may be inputted, and each of the conditions may be combined in AND or OR.

The UI includes a result list 250 which is a result input window through which a result is inputted. The expert (doctor) inputs result (knowledge) in accordance with a condition in the result input window. Here the inputted result may include an item (name) 251 and a value 252.

An opinion list 260 is a window for showing opinion depending on inputted condition and result.

Now referring to FIG. 1, the conversion unit 120 parses the inputted knowledge and converts the parsed knowledge to ontology-based rules. For example, the rule may be a SWRL-based rule. Justification includes information concerning respective rules. That is, the justification indicates the information concerning one rule and an explanation about relation between two nodes.

Here, the rule includes a condition node corresponding to the inputted condition, a result node corresponding to the inputted result and an edge for connecting the condition node to the result node. The edge comprises an edge direction and an edge value. The edge direction may be formed from the condition node to the result node, and the edge value may correspond to an explanation about relation between the condition node and the result node.

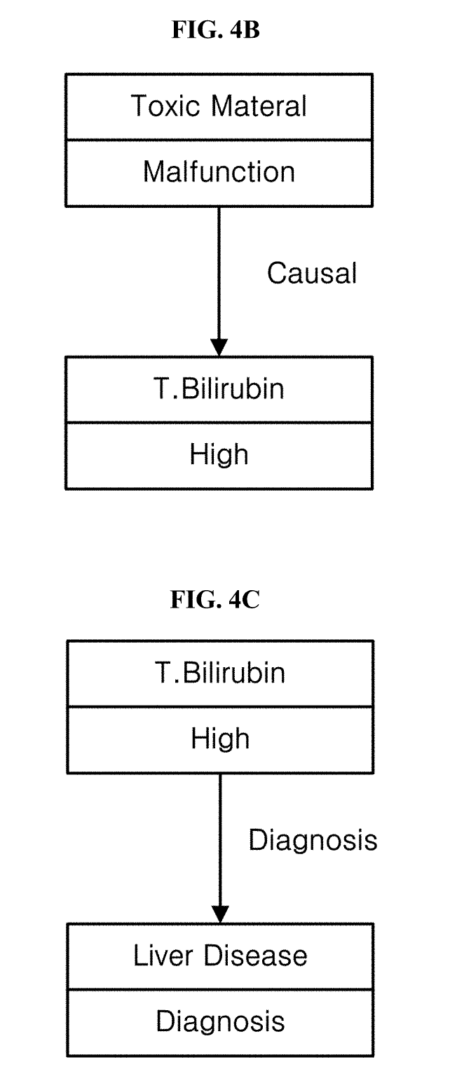

FIG. 3 is a view illustrating concept of a rule according to one embodiment of the invention.

In FIG. 3, relation between a condition node 310 and a result node 320 is based on one rule. Here, each of the condition node 310 and the result node 320 includes a node name and a node value.

An edge value has a Definition, Causal and Diagnosis rule.

The Definition is set to determine the node value of the result node by generalizing the node value of the condition node. That is, the Definition filters multiple item information to item information for respective cases. This is used for reasoning abnormality of the item based on a rule base for defining a normal value range rule for the item.

A rule in FIG. 4A is an example of a rule having the Definition. A sentence “T. Bilirubin has a high value in the event that the T. Bilirubin is 9.3” depends on the rule.

The Causal is set to express information corresponding to cause of the result node in the rule having the Definition. That is, the Causal is used for detailed additional explanation about a result obtained by the rule having the Definition. This may be directly written by the expert through the UI. The Causal is delivered to the storage unit 130 to be described below, and then it is stored according to the ontology-based rule.

A rule in FIG. 4B is an example of a rule having the Causal. A sentence “A cause by which T. Bilirubin has the high value is malfunction of toxic material” depends on the rule.

Diagnosis is set for expressing information corresponding to conclusion according to the result node in the rule having the Definition. The Diagnosis is defined in a rule base. In the Diagnosis, it is possible to perform addition, amendment and deletion.

A rule in FIG. 4C is an example of a rule having the Diagnosis. A sentence “it may be diagnosed to liver disease if T. Bilirubin has the high value” depends on the rule.

Now referring to FIG. 1, the storage unit 130 stores ontology including information. Here, the storage unit 130 may store prestored ontology and ontology in accordance with the rule converted by the conversion unit 120. For example, the rules converted by the conversion unit 120 may be shown in following Table 1.

TABLE 1

| rule | condition | result | explanation |
|---|---|---|---|
| Def-rule1 | (Name = | Name = T. Bilirubin | |
| | T. Bilirubin) | Value = High | |
| | [symbol] (8.7 < Value) | | |
| Dia-rule2 | Name = T. Bilirubin | Name = Liver | Explanation 1 |
| | Value = High | Disease | (omission) |
| | | Value = Diagnosis | |
| Cau-rule3 | Name = Hepatic | Name = Toxic | Explanation 2 |
| | Parenchymal Cell | Material | (omission) |
| | Value = | Value = | |
| | Malfunction | Malfunction | |
| Cau-rule4 | Name = Toxic | Name = T. Bilirubin | Explanation 3 |
| | Material | Value = High | (omission) |
| | Value = | | |
| | Malfunction | | |

The reasoning performing unit 140 reasons the conclusion by using the converted rules.

Particularly, when reasoning a conclusion of a rule A having Definition among the converted rules, the reasoning performing unit 140 searches a rule B which has Diagnosis as an edge value and a result node of the rule A as a condition node, and may reason a result node of the rule B as the conclusion.

The reasoning performing unit 140 generates an explanation about a rule corresponding to a cause of the conclusion.

Particularly, the reasoning performing unit 140 may search a rule C which has Causal as an edge value and the result node of the rule A/the condition node of the rule B as a result node, and generate an explanation about a rule corresponding to cause of the conclusion by using the rule C.

In this time, a rule D, which is a cause of the rule C, may exist. In this case, the reasoning performing unit 140 may search the rule D which has Causal as the edge value and the condition node of the rule C as the result node, and generate an explanation about a rule corresponding to a cause of the conclusion by using further the rule D. This process may be repeatedly performed until a node corresponding to a cause of explanation about the rule does not exist.

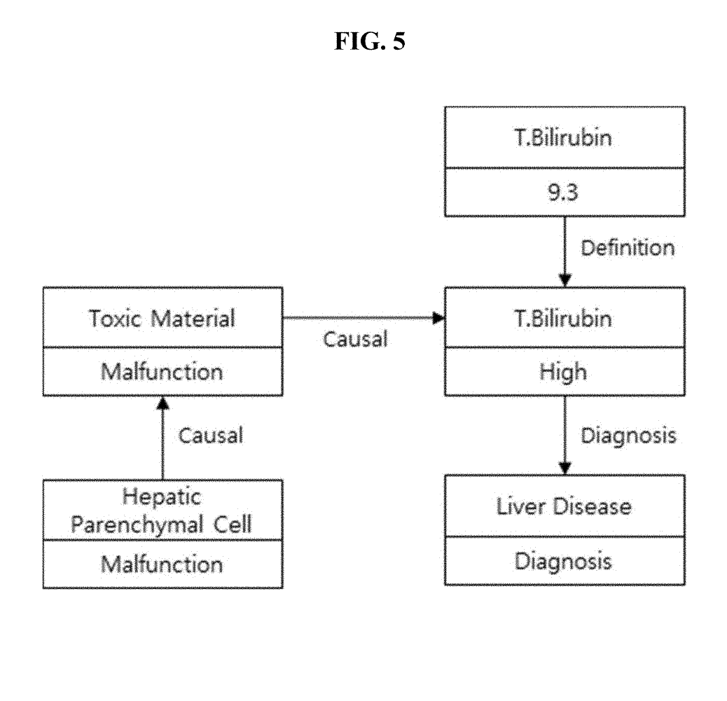

FIG. 5 is a view illustrating operation of the reasoning performing unit according to one embodiment of the invention.

In FIG. 5, patient information including sex, age, drinking, smoking, etc. and test value information for respective items in a blood screening test are inputted through the UI, and {T. Bilirubin, 9.3} is generated as the condition node of the rule A based on the inputted information. A test item having abnormal value in accordance with state of the patient is checked based on {T. Bilirubin, 9.3}. As a result, {T. Bilirubin, High} is generated as the result node of the rule A.

A rule of knowledge determined to diagnosis by input of the expert is a rule having Diagnosis. This corresponds to diagnosis of disease inferred from a test item of abnormal value generated in the conventional system. In this case, {Liver Disease, Diagnosis} as opinion about possible disease from {T. Bilirubin, High} is inferred (rule C).

Logical explanation may be inferred through the rule having Causal of rules inputted by the expert, so as to catch cause of diagnosis. Firstly, the reasoning performing unit 140 searches a rule (having Causal) corresponding to the test item of the abnormal value, and expands logically a node from corresponding rule. This will be performed by using the TABLE 1. Accordingly, a node {Toxic Material, Malfunction} is inferred as cause of a node {T. Bilirubin, High}, and it is expanded to a node {Hepatic Parenchymal Cell, Malfunction} through search of a rule including a node {Toxic Material, Malfunction}. This process is performed until related node does not exist. Explanation about relation between two nodes is added via justification about a rule related to the expanded node. The reasoning performing unit 140 generates logical explanation about cause of suspected disease from the test item of the abnormal value.

Briefly, the inputted rule may infer domain information collected by an inference engine based on the rule. The inference engine infers automatically a causal relation of the inputted rules, and an inferred result becomes domain knowledge in which logical explanation about the domain information is added. The reasoning apparatus may obtain and manage knowledge of the expert through interaction with the expert, and provide the logical explanation about the knowledge of the expert by reasoning the obtained knowledge of the expert according to an ontology-based rule.

Accordingly, the reasoning apparatus may manage experimental knowledge of the expert by a universal method capable of applying domains in various fields, thereby establishing knowledge base in accuracy, consistency and flexibility compared with the conventional system operated by the knowledge engineer.

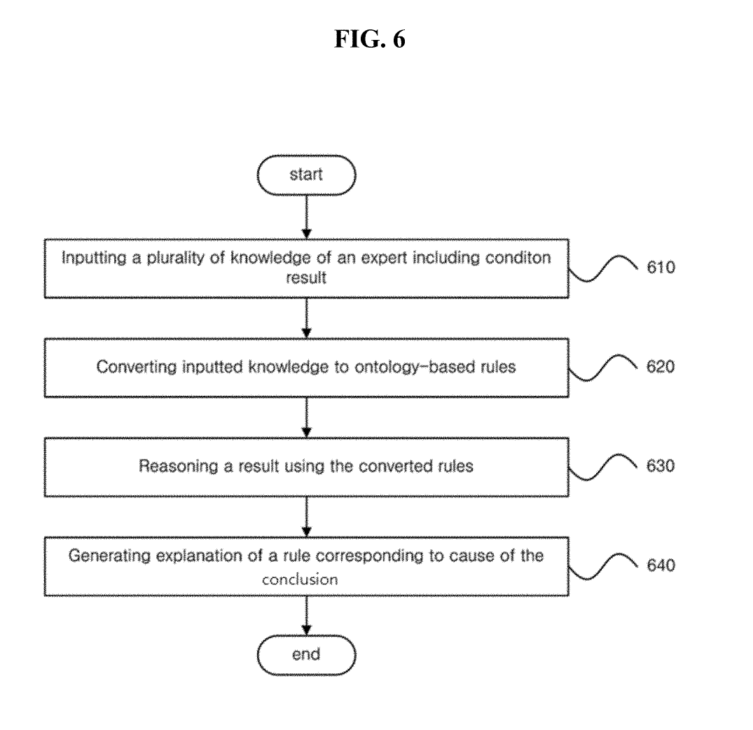

FIG. 6 is a flowchart illustrating an ontology-based reasoning method using knowledge of the expert according to one embodiment of the invention.

The method in FIG. 6 may be performed by an apparatus including a processor. Hereinafter, steps will be described.

In a step of 610, a plurality of knowledge of the expert including condition and a result are inputted.

In a step of 620, the apparatus converts the inputted knowledge to ontology-based rules. Here, the rule includes a condition node corresponding to inputted condition, a result node corresponding to inputted result and an edge for connecting the condition node to the result node. Each of the condition node and the result node includes a node name and a node value. The edge includes an edge direction set from the condition node to the result node and an edge value corresponding to an explanation about relation between the condition node and the result node.

The edge value may include a Definition for determining a node value of the condition node to a node value of the result node by generalizing the node value of the condition node, a Causal for expressing information corresponding to cause of the result node in a rule having the Definition, and a Diagnosis for expressing information corresponding to the conclusion based on the result node in the rule having the Definition.

In a step of 630, the apparatus reasons the conclusion by using the converted rules.

In one embodiment, when reasoning a conclusion of a rule A having Definition among the converted rules, the apparatus searches a rule B which has Diagnosis and a result node of the rule A as a condition node, and may reason a result node of the rule B as the conclusion in the step of 630.

In a step of 640, the apparatus generates an explanation about a rule corresponding to cause of the conclusion in the step of 640.

In one embodiment, the apparatus may search a rule C which has Causal and the result node of the rule A/the condition node of the rule B as a result node, and generate an explanation about a rule corresponding to cause of the conclusion by using the rule C in the step of 640.

In the above description, embodiments of the ontology-based reasoning method using the knowledge of the expert of the invention are described. Constitution of the ontology-based reasoning apparatus 100 using the knowledge of the expert described in FIG. 1 to FIG. 5 can be applied to the present embodiment. Accordingly, any further description will be omitted.

The technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

Components in the embodiments described above can be easily understood from the perspective of processes. That is, each component can also be understood as an individual process. Likewise, processes in the embodiments described above can be easily understood from the perspective of components. The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. An ontology-based reasoning apparatus using knowledge of an expert comprising:
an input unit through which a plurality of the knowledge of the expert including a condition and a result are inputted;
a conversion unit configured to convert the inputted knowledge to ontology-based rules; and
a reasoning performing unit configured to reason a conclusion by using the converted rules and generate an explanation of a rule corresponding to cause of the conclusion,
wherein the rule includes a condition node corresponding to the condition, a result node corresponding to the result and an edge for connecting the condition node to the result node, the edge includes an edge direction and an edge value, and the edge value corresponds to an explanation about relation between the condition node and the result node.

2. The ontology-based reasoning apparatus of claim 1, wherein the input unit transmits an UI (user interface) for obtaining the knowledge to a terminal of the expert,
and wherein the UI includes an information display window for displaying needed information when inputting the condition and the result, a condition input window for receiving the condition and a result input window for receiving the result.

3. The ontology-based reasoning apparatus of claim 1, wherein each of the condition node and the result node includes a node name and a node value, and the edge direction is set from the condition node to the result node.

4. The ontology-based reasoning apparatus of claim 2, wherein the edge value includes a Definition for determining a node value of the condition node to a node value of the result node by generalizing the node value of the condition node, a Causal for expressing information corresponding to cause of the result node in a rule having the Definition, and a Diagnosis for expressing information corresponding to the conclusion based on the result node in the rule having the Definition.

5. The ontology-based reasoning apparatus of claim 4, wherein when reasoning the conclusion about a rule A having the Definition among the converted rules, the reasoning performing unit
searches a rule B which has Diagnosis and a result node of the rule A as a condition node, and reasons a result node of the rule B as the conclusion, and
searches a rule C which has Causal and the result node of the rule A/the condition node of the rule B as a result node and generates an explanation about a rule corresponding to cause of the conclusion by using the rule C.

6. The ontology-based reasoning apparatus of claim 5, wherein the reasoning performing unit searches a rule D which has the Causal and a condition node of the rule C as a result node, and generates an explanation about a rule corresponding to the cause of the conclusion by using further the rule D.

7. An ontology-based reasoning method using knowledge of an expert in an apparatus including a processor, the method comprising:
receiving a plurality of the knowledge of the expert including a condition and a result;
converting the received knowledge to ontology-based rules;
reasoning a conclusion using the converted rules; and
generating an explanation about a rule corresponding to cause of the conclusion,
wherein the rule includes a condition node corresponding to the condition, a result node corresponding to the result and an edge for connecting the condition node to the result node, the edge includes an edge direction and an edge value, and the edge value corresponds to an explanation about relation between the condition node and the result node.

8. The method of claim 7, wherein each of the condition node and the result node includes a node name and a node value, and the edge direction is set from the condition node to the result node.

9. The method of claim 8, wherein the edge value includes a Definition for determining a node value of the condition node to a node value of the result node by generalizing the node value of the condition node, a Causal for expressing information corresponding to cause of the result node in a rule having the Definition, and a Diagnosis for expressing information corresponding to the conclusion based on the result node in the rule having the Definition.

10. The method of claim 9, wherein when reasoning the conclusion about a rule A having the Definition among the converted rules,
The step of the reasoning includes searching a rule B which has Diagnosis and a result node of the rule A as a condition node, and reasoning a result node of the rule B as the conclusion, and
The step of the generating the explanation includes searching a rule C which has Causal and the result node of the rule A/the condition node of the rule B as a result node and generating an explanation about a rule corresponding to cause of the conclusion by using the rule C.

11. A recording medium readable by a computer recording a program for performing the method according to any one of claim 7.
